(19) United States
(12) Patent Application Publication
(10) Pub. No.: US 2013/0101974 A1
(43) Pub. Date: Apr. 25, 2013

(54) SYSTEM AND METHOD FOR WIRELESS ASSESSMENT ADMINISTRATION AND DATA COLLECTION

(71) Applicant: Turning Technologies, LLC, Youngstown, OH (US)

(72) Inventors: Tina Rooks, Orlando, FL (US); David Chiszar, Naperville, FL (US); Jeffrey Cunningham, Hermitage, PA (US); Mike Broderick, Lake Milton, OH (US)

(73) Assignee: TURNING TECHNOLOGIES, LLC, Youngstown, OH (US)

(21) Appl. No.: 13/658,987

(22) Filed: Oct. 24, 2012

Related U.S. Application Data
(60) Provisional application No. 61/550,503, filed on Oct. 24, 2011.

(51) Int. Cl. G09B 7/00

(52) U.S. Cl. CPC G09B 7/00
USPC 434/353

(57) ABSTRACT

A portable storage apparatus is configured to interface with a computer having a processor. The portable storage apparatus comprises a wireless transceiver for transmitting and receiving data, an operating system, and a memory containing data representing a plurality of questions. The portable storage apparatus is configured to receive data representative of a question identification number, to communicate a question, from the plurality of questions, corresponding to the question identification number, to receive data representative of a response to the question, and to transmit the data representative of the response.

### PRIORITY

This application claims priority to U.S. Patent Application No. 61/550,503, filed on Oct. 24, 2011. The entirety of that application is incorporated herein

### FIELD OF INVENTION

The present disclosure relates to the field of assessment administration and more particularly, to a method and system to create a secure, closed wireless data communication network using an assessment stick.

### BACKGROUND

Assessment data is collected in various industries for various purposes. Assessment data may be collected, for example, to determine a student's comprehension of particular subject matter studied in a classroom, to determine whether an individual is qualified to receive a particular credential, and so on. An assessment may be administered by distributing test booklets or paper printouts of questions to participants. Participants respond to the questions by marking the paper printout. Scoring such paper printouts, however, is tedious and time consuming as well as error prone. Further, administering an assessment by paper is not secure and reliable since copies of the assessment may be misplaced, damaged, or stolen.

An assessment may also be administered using a computer. For example, a participant may be presented with questions on a computer screen and the participant may respond by inputting answers using the computer's peripherals. However, administering an assessment using a computer is not secure and reliable either. For example, a participant may use the computer to access resources during the assessment that improperly assist the participant in responding to the questions. In addition, a computer may rely on a network connection to administer an assessment. Not all environments in which an assessment is administered, however, have available network connections.

### SUMMARY OF THE INVENTION

A portable storage apparatus is configured to interface with a computer having a processor. The portable storage apparatus comprises a wireless transceiver for transmitting and receiving data, an operating system, and a memory containing data representing a plurality of questions. The portable storage apparatus is configured to receive data representative of a question identification number, to communicate a question, from the plurality of questions, corresponding to the question identification number, to receive data representative of a response to the question, and to transmit the data representative of the response.

A portable storage system is configured to interface with a computer comprising a processor. The portable storage apparatus comprises a wireless transceiver for transmitting and receiving data, a memory containing data representing a plurality of question identification numbers, and program instructions for execution by the processor of the computer. The program instructions comprise first program instructions configured to transmit data representative of a question identification number from the plurality of question identification numbers, second program instructions configured to receive data representative of a response corresponding to the question identification number, and third program instructions configured to store the data representative of the response.

A method for wirelessly administering an assessment, comprising the steps of disabling a first operating system to prevent the first operating system from accessing a computer, enabling a second operating system to allow the second operating system to access the computer, the computer, using the second operating system, wirelessly receiving data representative of a question identification number, the computer, using the second operating system, communicating a question corresponding to the question identification number, and the computer, using the second operating system, receiving data representative of a response to the question.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is an example wireless assessment administration system.

FIG. 2 is an example wireless assessment administration system

FIG. 3 is a block diagram of an example participant assessment stick of FIG. 1.

FIG. 4 is a block diagram of an example proctor assessment stick of FIG. 1.

FIG. 5 is a flow chart of an example method for wireless assessment administration with assessment sticks.

FIG. 6 is a flow chart of an example method for wireless assessment administration with assessment sticks.

FIG. 7 is a schematic diagram of an example computer for implementing the example system of FIG. 1.

### DETAILED DESCRIPTION

The following includes definitions of selected terms employed herein.

An “assessment” is an item response data collection and may be referred to as tests, surveys, evaluations, voting, polling, quizzes, certifications, or examinations, including interim, formative, summative, benchmark, or high stakes exams.

“Logic” includes but is not limited to hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

A “proctor” is a user, including both human users and computer or mechanical users, that administers the assessment.

A “participant” is a subject recording responses for the assessment.

A “portal” is a web based application with a database.

A “host computer station” refers to hardware capable of running an operating system and includes a desktop computer, laptop computer, tablet computer, mobile computing device, and smartphone.

A “test booklet” includes paper copy of question items, and questions displayed by other means, such as by an overhead projector or digital display, as well as questions that are audibly presented.

An “answer key” is a list of questions and question type which may or may not include correct answer indicators.

A “question” is a method of inquiry that requires the participant to consider and respond to one or more parts with one or more answers.

A “test publisher” is an entity that creates the test booklet.

A “assessment stick” is a portable computer memory device capable of interfacing with a computer station via Universal Serial Bus (USB) or other similar interface or input port such as an audio jack, while leveraging the computer peripheral devices, for the purpose of administering an assessment.

“Adaptive administration” is the administration of an assessment in which the questions presented to the participant are determined by an algorithm based on the participant performance during the assessment.

The definitions include various examples or forms of components that fall within the scope of a term and that may be used for implementation. The examples are not intended to be limiting. Both singular and plural forms of terms may be within the definitions.

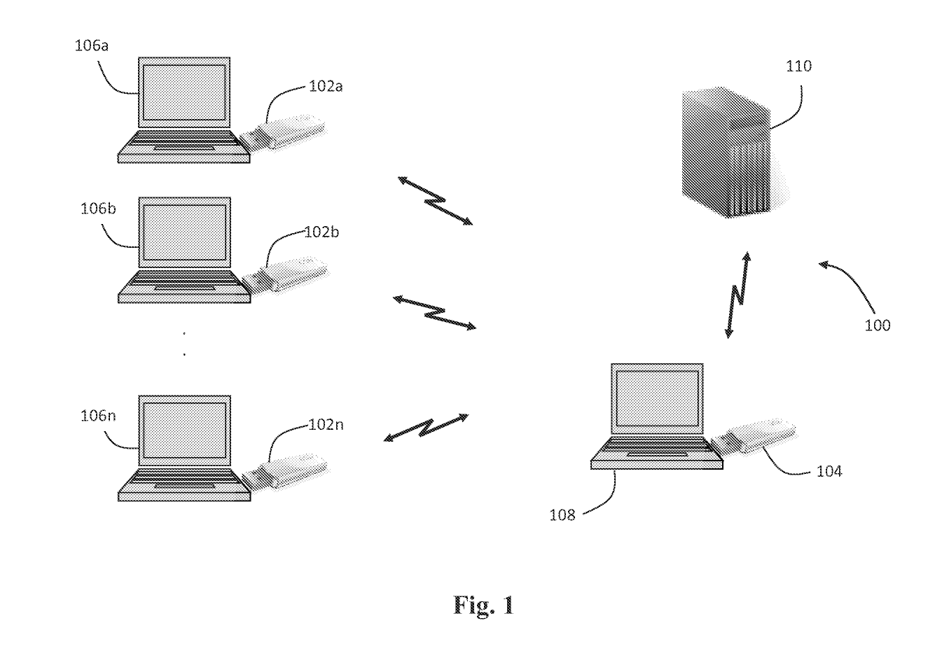

FIG. 1 illustrates an example wireless assessment administration system 100. System 100 includes a plurality of participant assessment sticks 102a, 102b, and 102n (hereinafter referred to as participant stick 102) in signal communication with a proctor assessment stick 104 (hereinafter referred to as proctor stick 104). In one embodiment, the participant stick 102 and proctor stick 104 communicate via radio frequency (RF) signals. It should be understood that, although three participant sticks and one proctor stick are illustrated, a proctor stick may be configured to accommodate one or many participant sticks. Therefore, system 100 may include any number of participant sticks and proctor sticks as deemed appropriate by a proctor or systems administrator.

Assessment stick 102 and proctor stick 104 together provide a secure and reliable testing environment, independent of external conditions of the testing environment. Using proctor stick 104, a proctor is able to administer a test, a survey, a poll, etc. to a student or other participant, regardless of computer hardware, software, operating system, or wireless connection available in the assessment environment. Thus, a proctor is able to quickly prepare a secure assessment environment for one or more participants. Proctor stick 104 wirelessly manages the participant's entry to an assessment, monitors, collects, and scores assessment data for one or more participants, via participant stick 102, with minimal environment setup and disruption or alteration of pre-existing computer configurations and is not reliant on an internet connection in order to transmit or receive data.

Participant stick 102 is configured to interface with a participant computer 106a, 106b, or 106n (hereinafter referred to as participant computer 106) to leverage the peripherals of participant computer 106. In one example, participant stick 102 is configured to interface with participant computer 106 via a Universal Serial Bus (USB) port. Alternatively, participant stick 102 may be configured to interface with participant computer 106 via another similar type of communication port, or hub such as Micro USB, an audio jack, etc.

Participant computer 106 may include an operating system, memory storage space, and peripheral devices. Alternatively, participant computer 106 may be a “dumb” terminal which includes peripheral devices but does not include an operating system or memory storage space. Participant computer 106 may or may not have a communications adapter, such as a Wi-Fi or radio frequency adapter, for communicating with other computing devices.

Participant stick 102 includes an operating system independent from any operating system on the participant computer 106. Participant stick 102 is configured to automatically boot the independent operating system upon interfacing with participant computer 106, to block access to participant computer's 106 operating system, thereby creating a secure testing environment.

Proctor stick 104 is configured to interface with a proctor computer 108, similarly to participant stick 104, in order to leverage the peripherals of proctor computer 108. Specifically, proctor stick 104 is configured to interface with proctor computer 108 via a USB port. Alternatively, proctor stick 104 may be configured to interface with proctor computer 108 via another type of communication port, or hub such as Micro USB, an audio jack, etc.

Participant stick 102 is able to wirelessly communicate with proctor stick 104 during administration of an assessment. In an example embodiment, the participant stick 104 communicates with proctor stick 104 via encrypted RF transmission or other similar technology. As a result, a closed, secure communication is established between participant stick 102 and proctor stick 104.

If an Internet connection is present, proctor stick 104 is able to wirelessly communicate with and transfer data to a web portal on a web server 110. A web portal on web server 110 may be configured to transfer the data to another location, such as a test publisher's web portal or a data warehouse, for example. If a connection to the web server 110 is unavailable, proctor stick 104 is configured to store data including responses until the data can be transferred to web server 110.

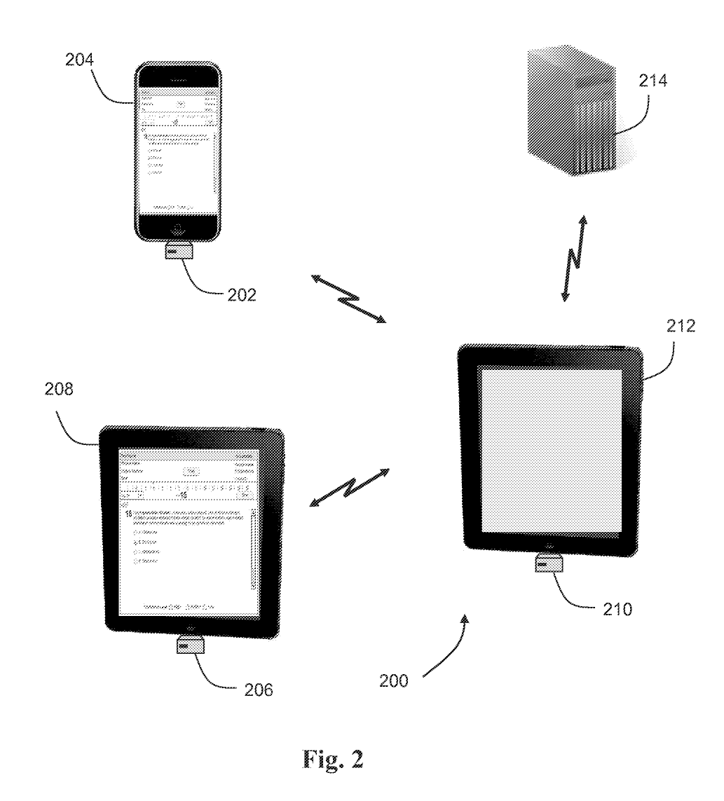

It should be understood that, although participant stick 102 and proctor stick 104 are depicted as elongated shapes, participant stick 102 and proctor stick 104 may take any shape. It should also be understood that, although participant computer 106 and proctor computer 108 are depicted as laptop computers, participant computer 106 and proctor computer may be desktop computers, tablet computers, smartphones, or any other suitable computing device. In addition, participant computer 106 and proctor computer 108 can be different types of computing devices. For example, FIG. 2 illustrates an example wireless assessment administration system 200 in which a first participant stick 202 is configured to interface with a smartphone 204 and a second participant stick 206 is configured to interface with a tablet computer 208, while a proctor stick 210 is configured to interface with a second tablet computer 212, which is configured to communicate with a web server 214. In other words, wireless assessment administration system 200 is configured using a mixed hardware environment in which combinations and types of interfaces may vary.

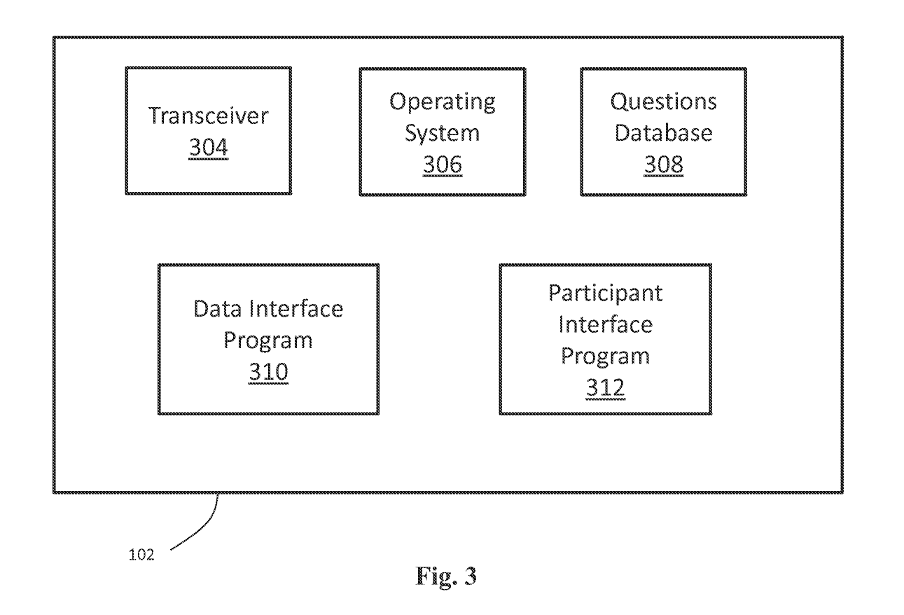

FIG. 3 is a block diagram of an example participant stick 102 of FIG. 1. Participant stick 102 includes a wireless transceiver 304 for transmitting and receiving data to and from proctor stick 104. In an example embodiment, transceiver 304 is a 2.4 GHz radio frequency (RF) transceiver. In an example embodiment, transceiver 304 is configured to communicate using 802.11, Bluetooth, Zigbee, 3G, 4G, or other similar wireless communication protocol. Alternatively, if a wireless network is available in the testing environment, participant stick 102 may communicate with proctor stick 104 via an existing Wi-Fi. Participant stick 102 may be configured to interface with a Wi-Fi adapter of the participant computer 106. In an example embodiment, participant stick 102 may also have built-in Wi-Fi adapter (not shown) for communicating via a wireless network, even when the participant computer 106 lacks a Wi-Fi adapter. Thus, in one example, assessment stick 102 is configured to act as a wireless access point.

Participant stick 102 includes an operating system 306 configured to interface with peripherals of participant computer 106. In other words, operating system 306 is configured to disable or run in place of an operating system of participant computer 106. Operating system 306 is further configured to block access to participants computer's 106 operating system as well as to any data or programs stored on participant computer 106. This results in a more secure assessment environment since a participant is prevented from accessing material on the computing device which may aid the participant in performing the assessment. Operating system 306 is further configured to enable participant stick 102 to leverage the peripherals of participant computer 106. These peripherals may include a keyboard, monitor, audio speakers, mouse, touch screen or other similar peripheral devices. Operating system 306 may include Windows, Mac, Linux, or another type of operating system, or a mobile operating system such as Android or iOS.

In one example, operating system 306 is configured to run automatically when participant stick 102 is interfacing with participant computer 106. In another example, operating system 306 is configured to run in response to a systems administrator executing a command. In one example, participant stick 102 is configured to receive the command remotely via transceiver 304. In one example, operating system 306 is configured to initiate a login process when starting up in order to verify credentials of a participant. Thus, operating system 306 may be configured to deny a participant access to an assessment and associated questions if a participant fails to provide appropriate access credentials.

Participant stick 102 includes a questions database 308 for storing assessment questions. Questions database 308 may include one or more static assessments which may include one or more questions. Questions database 308 may also include a pool of questions for use in administrating an adaptive assessment. Questions database 308 may store question identification numbers corresponding to stored questions, correct answers corresponding to the questions to be used for scoring responses, and other similar data corresponding to assessment questions.

Participant stick 102 includes participant assessment software including a data interface program 310 and a participant interface program 312 that are configured to be executed by a processor of participant computer 106 using operating system 306. Data interface program 310 and a participant interface program 312 are also configured to leverage the peripherals of participant computer 106.

Data interface program 310 is configured to receive a question identification number, via transceiver 304, from proctor stick 104. The question identification number is indicative of a next question to ask on an assessment. Since participant stick 102 already contains all of the questions in questions database 308, the proctor stick 104 does not need to transmit an entire question to participant stick 102. Instead, only a question identification number associated with the selected question needs to be transmitted to participant stick 102. Avoiding the need to transmit the actual question helps protect the integrity and the security of the assessment and also help eliminate the need for a large amount of wireless bandwidth which may be required to transmit the actual questions.

In one example, data interface program 310 is configured to provide access credentials to proctor stick 104 and in turn receive question identification numbers based on the access credentials. Data interface program 310 is also configured to transmit a response corresponding to the question identification number, via transceiver 304, back to proctor stick 104.

Participant interface program 312 is configured to identify, in questions database 308, a question corresponding to a received question identification number and to communicate the question to a participant via at least one peripheral of participant computer 106. For example, interface program 312 may display the question on a screen, present the question audibly using a speaker, and so on. Participant interface program 312 is further configured to receive a response from a participant via at least one peripheral such as a mouse or a keyboard.

In one example, participant interface program 312 is configured to score the response while data interface program 310 is configured to transmit the score to proctor stick 104. Participant interface program 312 compares a received response to a stored answer in questions database 308 to determine a score.

In one example, data interface program 310 is configured to store a response to a question in questions database 308, thus enabling responses to be transferred to web server 110 after an assessment is complete in the event that participant stick 102 is not able to establish communication with proctor stick 104 during the assessment. This can result from a disabled or disconnected proctor stick 104. In other words, in one example, participant stick 102 is capable of functioning independently of proctor stick 104. In one example, data interface program 310 may be configured to encrypt responses, to time stamp responses, or to associate other relevant information with a response before storing or transmitting the response. In one example, for added security, participant stick is configured to only transmit responses to proctor stick 104 after receiving valid login credentials from a proctor or a systems administrator.

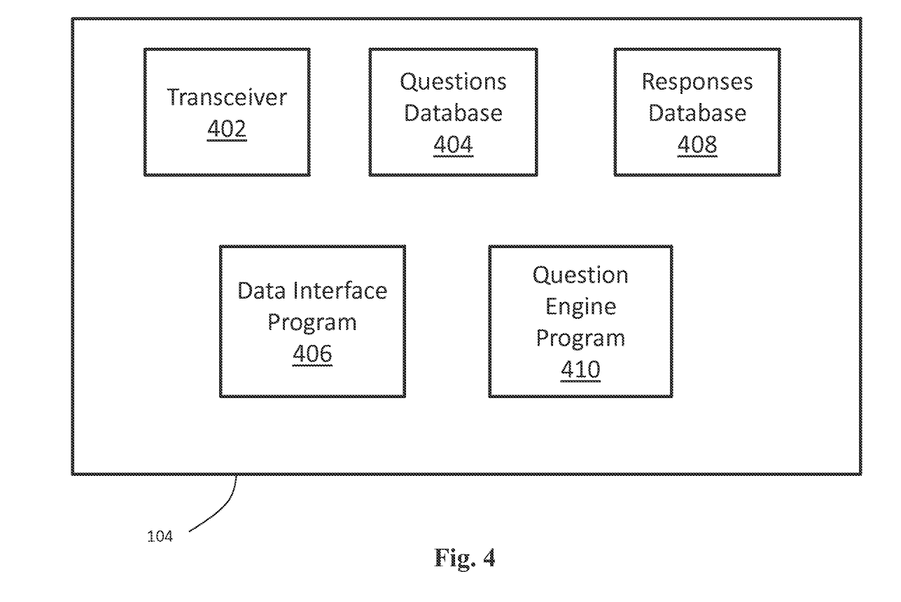

FIG. 4 is a block diagram of an example proctor assessment stick 104 of FIG. 1. Proctor stick 104 includes a wireless transceiver 402 for transmitting and receiving data to and from participant stick 102. In an example embodiment, transceiver 402 is a 2.4 GHz radio frequency (RF) transceiver. In an example embodiment, transceiver 402 is configured to communicate using 802.11, Bluetooth, Zigbee, 3G, 4G, or other wireless communication protocol. Alternatively, if a wireless network is available in the testing environment, proctor stick 104 may communicate with participant stick 102 via an existing Wi-Fi. Proctor stick 104 may make use of a Wi-Fi adapter of the proctor computer 108. In an example embodiment, proctor stick 104 may also have built-in Wi-Fi adapter (not shown) for communicating via a wireless network, even when the proctor computer 108 lacks a Wi-Fi adapter. Thus, in one example, proctor stick 104 is configured to act as a wireless access point.

Proctor stick 104 may or may not have an independently bootable operating system (not shown) and may or may not block an underlying operating system of proctor computer 108 during the administration of an assessment.

Proctor stick 104 includes a questions database 404 for storing assessment questions. Questions database 404 may include one or more static assessments which may include one or more questions. Questions database 404 may also include a pool of questions for use in administrating an adaptive assessment. Questions database 404 may store question identification numbers corresponding to stored questions, correct answers corresponding to the questions to be used for scoring responses, and other similar data corresponding to assessment questions.

Proctor stick 104 includes proctor assessment software including a data interface program 406 that is configured to be executed by a processor of proctor computer 108. In one example, interface program 406 is configured to be executed using an independent operating system (not shown).

Data interface program 406 is configured to transmit a question identification number, via transceiver 402, to participant stick 102. The question identification number is indicative of a next question to ask on an assessment. In one example, data interface program 406 may be configured to receive access credentials from participant stick 102 and in turn transmit question identification numbers to participant stick 102 based on the access credentials.

Data interface program 406 is also configured to receive a response corresponding to the question identification number, via transceiver 402, from participant stick 102 and to store the response in responses database 408. In one example, data interface program 406 may be configured to encrypt responses, to time stamp responses, or to associate other relevant information with a response before storing the response.

Proctor stick 104 includes a question engine program 410 configured to select questions from questions database 404 and to provide associated question identification numbers to data interface program 406. In one example, question engine program 410 is configured to select questions from questions database 404 according to a predefined order. For example, questions database 404 may define a particular assessment to include a specific series of questions to be answered in a specific order. In one example, question engine program 410 is configured to select questions from questions database 404 adaptively. For example, question engine program 410 may be configured to receive a response from data interface program 406, and to select a next question from questions database 404 based on the received response. In one example, question engine program is configured to enable a proctor to manually select a question for a participant.

In one example, question engine program 410 is also configured to calculate a score for a response and to store the score in responses database 408. Question engine program 410 compares a received response to a stored answer in questions database 404 to determine a score.

It should be understood that although the example system and method for wireless data collection is being described to include at least one participant stick and at least one proctor stick, the system and method can be implemented without a proctor stick. In such an example, the resources necessary for a proctor to administer an assessment, such as a question engine, a database of questions and associated metadata, and a database for storing student responses, would be loaded on a computer station. Accordingly, the participant stick would be configured to communicate with the computer station, rather then with a proctor stick or communicate directly with the server, network, cloud or host network directory.

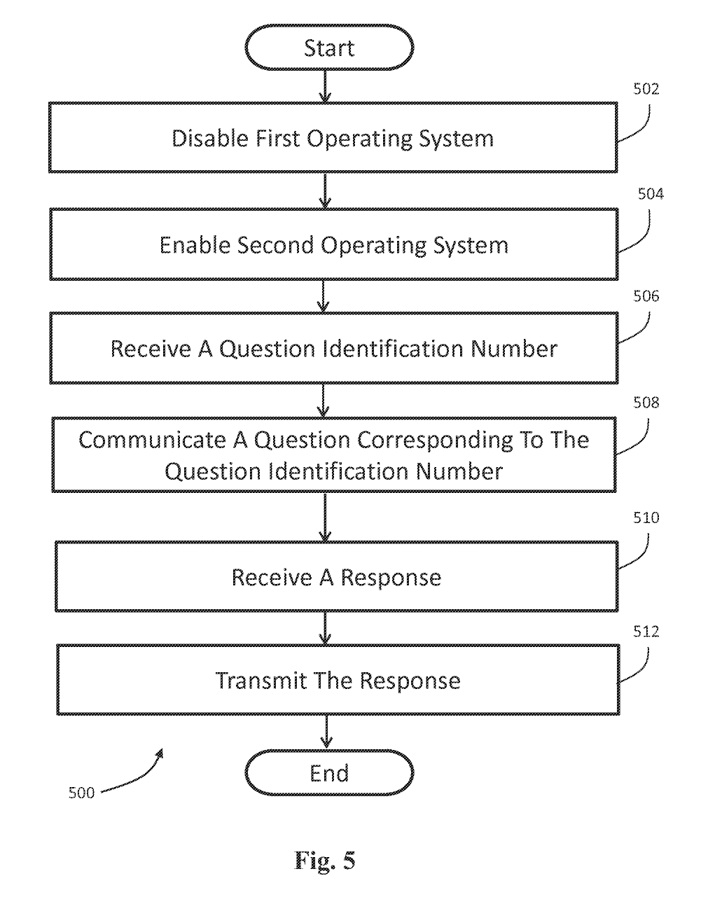

FIG. 5 is a flow chart of an example method 400 for wireless assessment administration with assessment sticks. At step 502, a participant stick 102 disables a first operating system of a participant computer 106. At step 504, participant stick 102 enables a second operating system 306 stored on participant stick 102. Thus, a secure assessment environment is created in which a participant is prevented from accessing materials on participant computer 106 which may provide the participant with an advantage during the assessment.

At step 506, participant stick 102 receives a question identification number from a proctor stick 104. At step 508, participant stick 102 determines a question that corresponds to the question identification number and communicates the question to a participant. Participant stick 102 communicates the question using the peripherals of participant computer 106, such as a display screen or audio speakers.

At step 510, participant stick 102 receives a response to the question via the peripherals of participant computer 106, such as a mouse or a keyboard. In one example, participant stick 106 scores the response by comparing the response to a stored answer.

At step 512, participant stick 102 transmits the response to proctor stick 104. In one example, participant stick 102 stores the response before attempting to transmit the response. Thus, the response is backed-up in the event that the response is not transferred successfully to proctor stick 104.

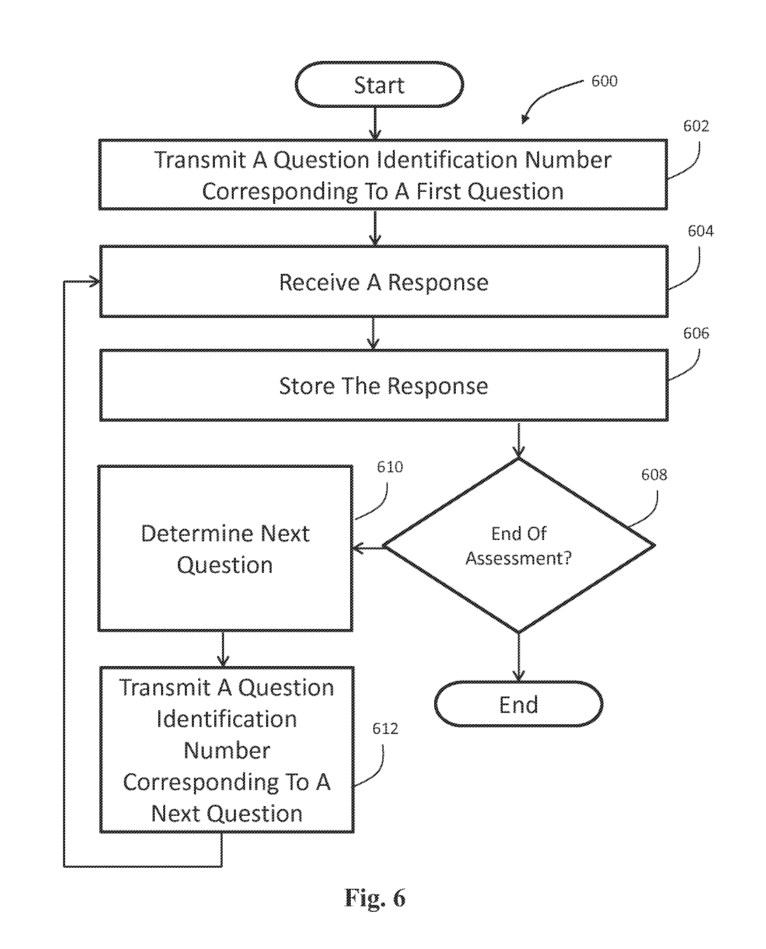

FIG. 6 is a flow chart of an example method 600 for wireless assessment administration with assessment sticks. At step 602, a proctor stick 104 transmits a question identification number corresponding to a first question to a participant stick 102. A first questions may be selected based on information already known about a particular participant or based on information obtained during a login process. In one example, proctor stick 104 first disables an operating system of a proctor computer 108 with which it is interfacing and enables an independent operating system before allowing a proctor to begin administering an assessment.

At step 604, proctor stick 104 receives a response to the first question from participant stick 102 and stores the response at step 606. In one example, proctor stick 104 stores the response in a local storage space. In one example, proctor stick 104 transfers the response to a web portal on a web server 110 for storage. The responses may be transferred to the web server 110 via a wireless connection, a wired connection, or by interfacing proctor stick 104 directly with the web server 110.

At step 608, proctor stick 104 determines whether an end of an assessment has been reached. In one example, once a participant has answered a final question and the assessment has been completed, proctor stick 104 may notify participant accordingly. For example, proctor stick 104 may notify participant stick 102 that the participant is permitted to access to the operating system and other data of participant computer 106 after the assessment is complete. In one example, a student may be required to disassociate or remove participant stick 102 from the participant computer 106 before the student is able to access to the operating system of participant computer 106.

If the end of the assessment has not yet been reached, proctor stick 104 determines a next question at step 610 by selecting a question from questions database 404. The question may be pre-selected or it may be adaptive. Proctor stick then transmits a question identification number corresponding to the next question to participant stick 102 at step 612. Proctor stick repeats this process until the end of an assessment is reached.

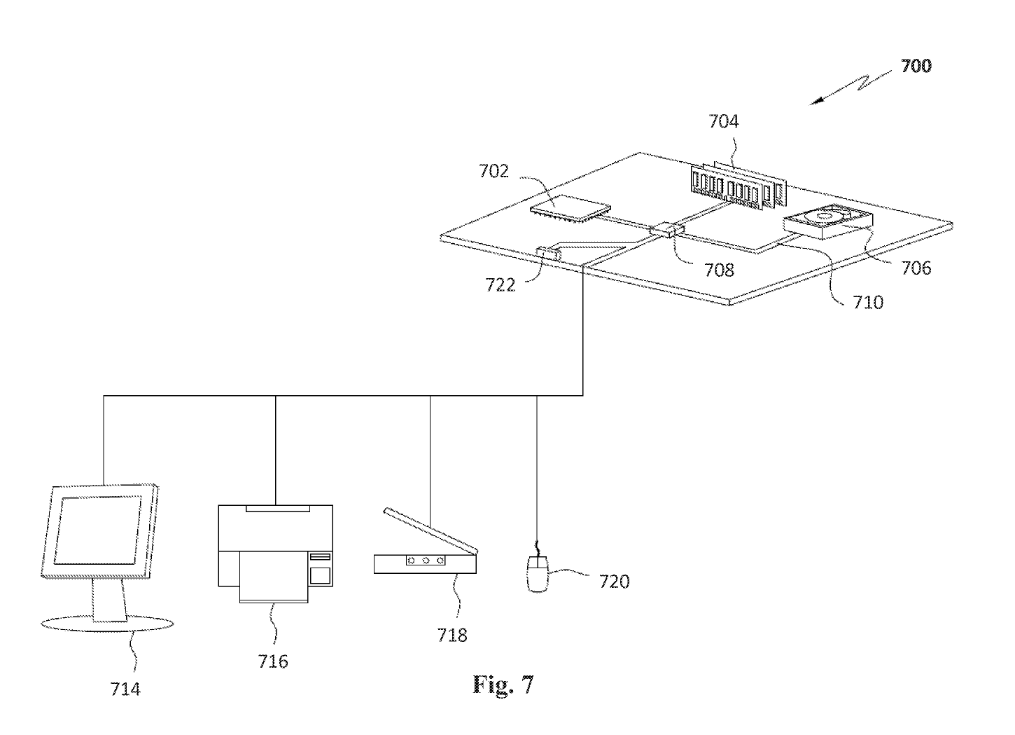

FIG. 7 is a schematic diagram of an example computer for implementing the example system of FIG. 1. The example computer 700 is intended to represent various forms of digital computers, including laptops, desktops, handheld computers, tablet computers, servers, and other similar types of computing devices. Computer 700 includes a processor 702, memory 704, a storage device 706, and a communication port 708, operably connected by an interface 710 via a bus 712.

Processor 702 processes instructions, via memory 704, for execution within computer 700. In an example embodiment, multiple processors along with multiple memories may be used.

Memory 704 may be volatile memory or non-volatile memory. Memory 704 may be a computer-readable medium, such as a magnetic disk or optical disk. Storage device 706 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 704 or storage device 706.

Computer 700 can be coupled to one or more input and output devices such as a display 714, a printer 716, a scanner 718, and a mouse 720.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A portable storage apparatus configured to interface with a computer having a processor, the portable storage apparatus comprising:
a wireless transceiver for transmitting and receiving data;
an operating system; and
a memory containing data representing a plurality of questions; and
wherein the portable storage apparatus is configured to:
receive data representative of a question identification number;
communicate a question, from the plurality of questions, corresponding to the question identification number;
receive data representative of a response to the question; and
transmit the data representative of the response.

2. The portable storage apparatus of claim 1, further configured to calculate a score corresponding to the response and to transmit data representative of the score.

3. The portable storage apparatus of claim 1, wherein the data representative of the question identification number is adaptive and determined based on transmitted data representative of a previous response.

4. The portable storage apparatus of claim 1, further comprising an interface for interfacing with the computer.

5. The portable storage apparatus of claim 1, wherein the portable storage apparatus is configured to receive the data representative of the question identification number from a second portable storage apparatus, and wherein the portable storage apparatus is configured to transmit the data representative of the response to the second portable storage apparatus.

6. The portable storage apparatus of claim 5, wherein the portable storage apparatus is configured to interface with a smartphone, and wherein the second portable storage apparatus is configured to interface with a tablet computer.

7. The portable storage apparatus of claim 1, wherein the wireless transceiver is a radio frequency transceiver.

8. The portable storage apparatus of claim 1, wherein the computer comprises a primary operating system, and wherein the operating system of the portable storage apparatus is configured to disable the computer's primary operating system.

9. A portable storage system configured to interface with a computer comprising a processor, the portable storage apparatus comprising:
a wireless transceiver for transmitting and receiving data;
a memory containing data representing a plurality of question identification numbers; and
program instructions for execution by the processor of the computer, comprising
first program instructions configured to transmit data representative of a question identification number from the plurality of question identification numbers;
second program instructions configured to receive data representative of a response corresponding to the question identification number; and
third program instructions configured to store the data representative of the response.

10. The portable storage system of claim 7, further comprising an operating system configured to disable a computer's primary operating system, wherein the program instructions are configured for execution by the processor of the computer using the operating system.

11. The portable storage system of claim 7, the program instructions further comprising fourth program instructions configured to calculate a score corresponding to the response, wherein the third program instructions are further configured to store data representative of the score.

12. The portable storage system of claim 7, the program instructions further comprising fourth program instructions configured to adaptively determine a question identification number based on stored data representative of a previous response.

13. The portable storage system of claim 7, further comprising a physical interface for interfacing with the computer.

14. The portable storage system of claim 7, wherein the wireless transceiver is a radio frequency transceiver.

15. The portable storage system of claim 7, the program instructions further comprising fourth program instructions configured to transmit the data representative of the response.

16. A method for wirelessly administering an assessment, comprising the steps of:
disabling a first operating system to prevent the first operating system from accessing a computer;
enabling a second operating system to allow the second operating system to access the computer;
the computer, using the second operating system, wirelessly receiving data representative of a question identification number;
the computer, using the second operating system, communicating a question corresponding to the question identification number; and
the computer, using the second operating system, receiving data representative of a response to the question.

17. The method of claim 16, further comprising the step of the computer, using the second operating system, calculating a score corresponding to the response.

18. The method of claim 16, further comprising the step of establishing communication with the computer using a physical interface.

19. The method of claim 16, further comprising the step of the computer, using the second operating system, wirelessly transmitting the data representative of the response.

20. The method of claim 16, further comprising the step of the computer, using the second operating system, storing the response on a portable storage device.
